(19) United States
(12) Patent Application Publication
(10) Pub. No.: US 2015/0134189 A1
(43) Pub. Date: May 14, 2015

(54) SYSTEMS AND METHODS FOR REMAINING USEFUL LIFE PREDICTIONS IN DRIVETRAINS

(71) Applicant: Ricardo, Inc., Van Buren Township, MI (US)

(72) Inventor: Anthony J. Wash, Belleville, MI (US)

(73) Assignee: Ricardo, Inc., Van Buren Township, MI (US)

(21) Appl. No.: 14/075,279

(22) Filed: Nov. 8, 2013

(51) Int. Cl. G07C 5/00

(52) U.S. Cl. CPC G07C 5/006
USPC 701/29.4

(57) ABSTRACT

Systems and methods for continually determining the remaining useful life of a drivetrain. The remaining useful life is continually determined during real-time operation of the drivetrain by determining a duty cycle based on torque and rotary speed measurements of the drivetrain. The duty cycle is converted into a useful life reduction, which is subtracted from the then-existing remaining useful life of the drivetrain. The systems and methods can additionally include displaying a remaining useful life during operation of the drivetrain, and generating an alert when the remaining useful life approaches or reaches zero. The drivetrain is optionally associated with an internal combustion engine, a wind turbine, or a gas turbine.

### BACKGROUND OF THE INVENTION

The present invention relates to systems and methods for estimating the remaining useful life of rotating machinery, and in particular drivetrains.

Drivetrains are used across a range of industries. For example, wind turbines include a drivetrain to transfer torque from a main rotor shaft to an electric generator, and gas turbines include a drivetrain to transfer torque from turbine blades to an electric generator. Also by example, wheeled and tracked vehicles include a drivetrain to transfer torque from a prime mover, such as an engine or a motor, to a drive axle. Drivetrains also include other rotating machinery having gears, bearings and/or shaft arrangements that transmit torque.

In these and other applications, drivetrains are typically designed to meet a design life that is suitable for the intended application. The design life normally assumes a range of expected torque loads. However, the expected torque loads almost always differ from the actual torque loads experienced under fielded operating conditions. As a result, drivetrains sometimes experience accelerated wear and deterioration to the point of failure long in advance of a scheduled inspection and/or drivetrain overhaul.

Though not widespread, some existing systems attempt to predict drivetrain failure based on averaged torque loads. However, averaged torque loads can mask significant fluctuations in torque that might accelerate the onset of fatigue failure. Consequently, existing systems can fall short of predicting drivetrain failure, ultimately leading to untimely service interruptions and costly emergency repairs.

### SUMMARY OF THE INVENTION

Systems and methods for determining a remaining useful life are provided. The systems and methods determine a remaining useful life based on actual operating conditions, and in particular the torque loads at a location along a drivetrain as regularly sampled over a recurring measurement interval. By determining a remaining useful life based on actual operating conditions, and not predicted operating conditions, the systems and methods of the present invention can provide an increased measure of predictability in drivetrain systems.

In one embodiment, a system includes a torque transducer and a control module electrically coupled to the torque transducer. The torque transducer measures torque at a location along a drivetrain, and the control module converts the torque measurement into a duty cycle. The control module determines a useful life reduction based on the duty cycle and subtracts the useful life reduction from the then-existing remaining useful life to determine a new remaining useful life.

In another embodiment, a system and a method for estimating a remaining useful life includes determining each duty cycle based on drivetrain torque and one or more environmental variables. The duty cycle is determined based on the torque load, the number of revolutions at the torque load, and the operating time at the torque load. The environmental variables can include, for example, component temperatures, fluid pressures, fluid conditions, wind speeds, generator speeds, and system vibrations.

In another embodiment, a system and a method for estimating a remaining useful life includes measuring drivetrain torque and drivetrain speed. The method further includes determining a duty cycle for each torque measurement and speed measurement, and determining a remaining useful life based on drivetrain operation at each determined duty cycle. The method can include generating an alert if the remaining useful life is below a minimum value or approaches zero.

The systems and methods can continually update and share the remaining useful life with interested parties. In addition, the systems and methods can determine a remaining useful for multiple subcomponents of a single drivetrain, optionally using an original calculated design life as a baseline value. The systems and methods can be used in conjunction with essentially any drivetrain, including for example drivetrains associated with internal combustion engines, wind turbines, and gas turbines.

These and other features and advantages of the present invention will become apparent from the following description of the invention, when viewed in accordance with the accompanying drawings and appended claims.

### BRIEF DESCRIPTION OF THE DRAWINGS

FIG. 1 is an illustration of a system for determining a remaining useful life of a wind turbine drivetrain in accordance with one embodiment.

FIG. 2 is an illustration of a system for determining a remaining useful life of an automobile drivetrain in accordance with another embodiment.

FIG. 3 is an overview for a method of determining a remaining useful life in accordance with one embodiment.

FIG. 4 is a flow chart illustrating a method of determining a remaining useful life in accordance with the embodiment of FIG. 3.

### DETAILED DESCRIPTION OF THE CURRENT EMBODIMENTS

The current embodiments include systems and methods for remaining useful life predictions in drivetrains. The current embodiments use torque measurements, speed measurements, and/or environmental variables to determine the remaining useful life based on actual drivetrain operating conditions. As used herein, drivetrains include essentially any system for transmitting torque loads, including systems having shafts, stators, rotors, gears, and/or bearings. Such drivetrains include rotary systems in wind turbines, gas turbines, wheeled vehicles and/or tracked vehicles, for example.

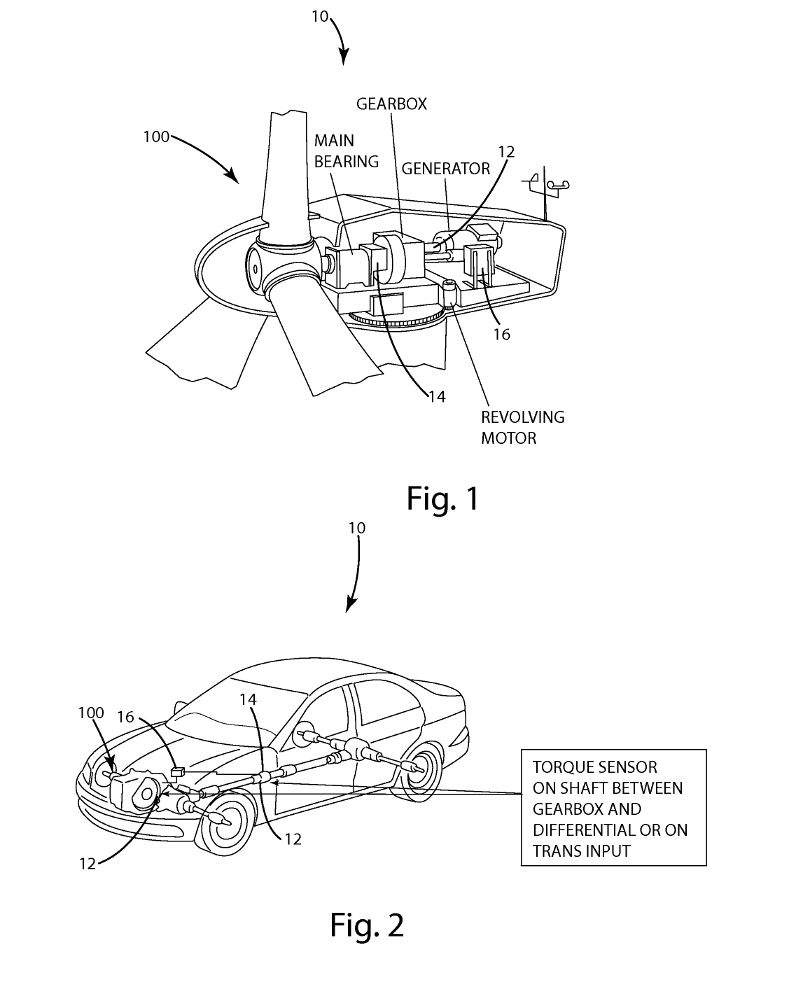

Referring now to FIGS. 1-2, a system for determining a remaining useful life is illustrated and generally designated 10. The system generally includes a torque transducer 12, a speed sensor 14, and a control module 16 electrically coupled to the torque transducer 12 and the speed sensor 14. As shown in FIG. 2, the torque transducer 12 measures torque at a location along a drivetrain 100 for a wind turbine. As alternatively shown in FIG. 2, the torque transducer 12 measures torque at two locations along a drivetrain 100 for an automobile. The torque transducer 12 can include essentially any sensor adapted to convert a dynamic torque load into an electrical signal. Suitable torque transducers can include strain gauge torque sensors, magnetic torque sensors, and surface acoustic wave (SAW) torque sensors. Other torque sensors can be used in other embodiments where desired. The torque sensor 12 provides an electrical output to the control module 16 indicative of the torque load on the drivetrain 100. For example, the electrical output can include a 0 to 5 VDC signal that is proportional to the measured torque load. As the term is used herein, electrically coupled includes both direct and indirect electrical connections, as well as wired and wireless electrical connections. For example, a SAW torque sensor can include a wireless electrical connection to a receiver unit associated with the control module 16.

As also noted above, the system 10 of the present embodiment includes a rotational speed sensor 14. The rotational speed sensor 14 can include any sensor adapted to convert rotary speed of the drivetrain 100 into an electrical signal. For example, the speed sensor 14 can include a magneto-electric or an inducto-electric rotational speed sensor, while other speed sensors can be used in other embodiments as desired. The speed sensor 14 can optionally provide a 0 to 5 VDC signal that is proportional to the measured rotational speed of the drivetrain 100, and more particularly a gear, a shaft, a rotor, or other component of the drivetrain 100. The output of the speed sensor 100 is communicated to the control module 16 by direct or indirect electrical connections, as well as by wired or wireless electrical connection.

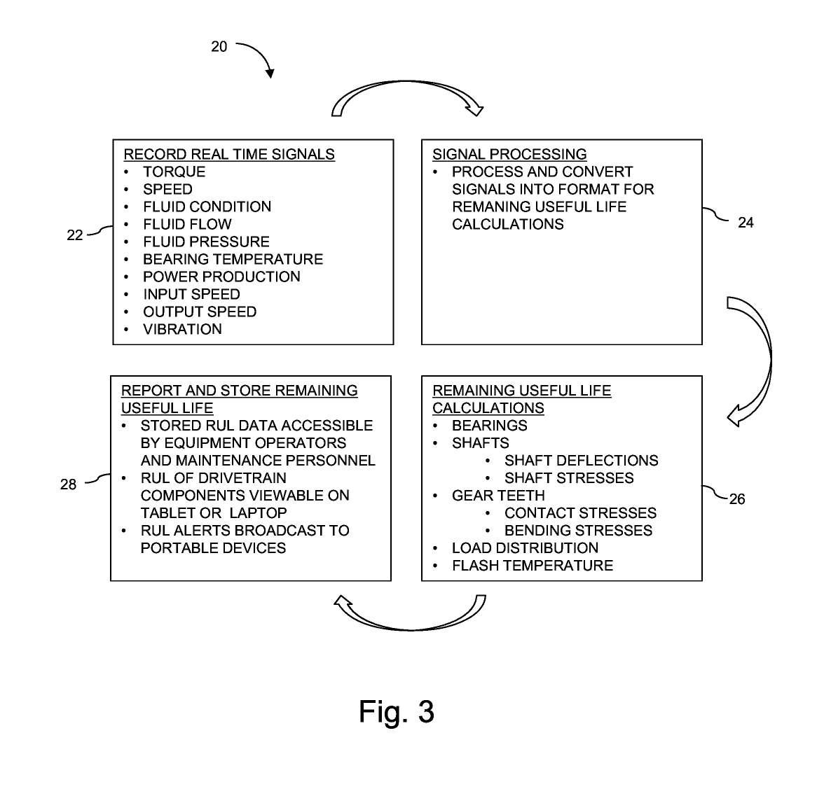

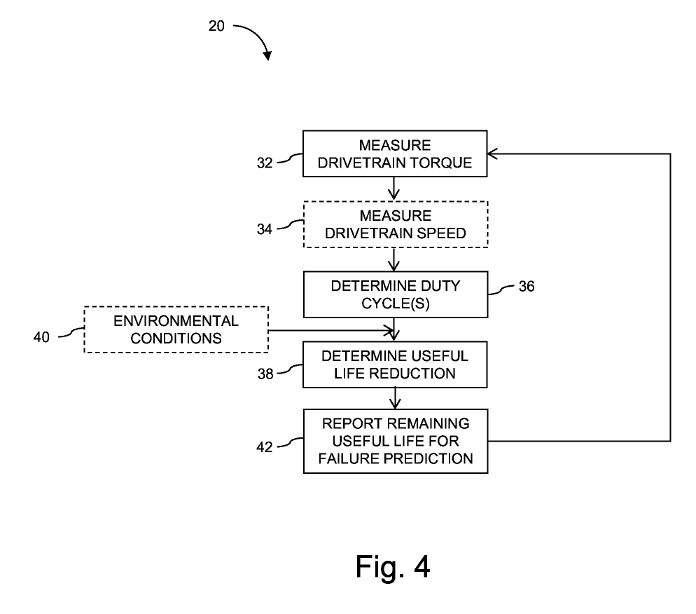

The control module 16 is adapted to process the output of the torque transducer 12 and the speed sensor 14. The control module 16 can include a processor, for example an application specific integrated circuit (ASIC) or a programmable logic controller (PLC), and a computer readable memory, for example a solid state memory. The processor is generally preprogrammed with a series of instructions that, when executed, cause the controller 16 to continually calculate a remaining useful life according to the method steps discussed below in connection with FIGS. 3-4. The control module 16 can be a standalone device in some embodiments, while in other embodiments the control module 16 is embedded into a machine or a system that uses the output of the control module for a useful result. For example, the control module 16 can form part of a Controller Area Network in automotive applications, power generating applications, and industrial applications. As set forth more fully below, the control module 16 can update and share the remaining useful life across the Controller Area Network, optionally alerting interested parties when the remaining useful life approaches a pre-specified level.

As generally shown in FIG. 3, a method of determining a remaining useful life is illustrated and generally designated 20. The method generally includes four phases of operation: signal acquisition 22, signal processing 24, remaining useful life calculations 26, and reporting and storing 28. Signal acquisition 22 includes a range of real time drivetrain measurements, including for example drivetrain torque, drivetrain speed, and one or more environmental conditions. As discussed below in connection with FIG. 4, signal processing 24 includes converting the real time measurements into a usable format, optionally including one or more duty cycles. As also discussed below in connection with FIG. 4, the remaining useful life calculations 26 include determining a remaining useful life based on the signal processing phase 24. The remaining useful life is then stored into memory and made available to interested parties at phase 28.

As more particularly shown in FIG. 4, the method 20 generally includes determining a duty cycle and, based on the duty cycle, determining a useful life reduction. The method 30 includes steps 32 through 42 that are performed by the system 10 of FIGS. 1-2 in the present embodiment, while in other embodiments the method steps are performed by other than the system 10 of FIGS. 1-2. These method steps relate to operation of a drivetrain under fielded conditions, wherein a useful life reduction is determined at the conclusion of a repeating measurement interval. This repeating measurement interval, T, is a time domain having a duration that can depend, at least in part, on the control module processing power. For illustrative purposes only, the measurement interval T can span ten seconds in some embodiment, while in other embodiments the measurement interval T can span fifteen minutes.

More particularly, the method 20 generally includes measuring drivetrain torque and measuring drivetrain speed during operation the drivetrain 100 under fielded conditions at steps 32 and 34, respectively. In particular, a torque transducer converts drivetrain torque into a first electrical output at step 32, and a speed sensor converts drivetrain speed into a second electrical output at step 34. The control module 16 then stores the electrical output of each sensor to memory. The electrical outputs can be continuous or pulsed, for example, with the torque sensor output being indexed to coincide with the speed sensor output. For example, the electrical outputs can be entered in parallel into a single shift register in memory. In addition, the torque and speed measurements can relate to the same location along the drivetrain 100, including for example a shaft, a bearing assembly, a rotor assembly, or a gear assembly.

At step 36, the control module 16 determines the drivetrain duty cycle(s). The drivetrain duty cycle(s) can depend, entirely or in part, on the measured torque and speed values. In a first example, the drivetrain duty cycle(s) can depend on the torque value and/or speed value at each sample time t within the measurement interval T. For illustrative purposes, a first duty cycle might include any torque between 1.0 k-1.2 k newton-meters (N·m) at speeds between 2.0 k-2.5 k revolutions per minute (r/min), while a second duty cycle might include any torque between 1.2 k-1.4 k N·m at speeds between 2.0 k-2.5 k r/min. Further in this example, a measurement of 1.1 k N·m and 2.1 k r/min at time t₁ would classify within the first duty cycle, while a measurement of 1.3 k N·m and 2.4 k r/min at time t₂ would classify within the second duty cycle, wherein the measurement interval T includes sample times t₁, t₂ to tₙ. To adequately account for potential torque fluctuations—including bending and reversing bending—the time domain for each subinterval (Δt) is sufficiently small, being significantly less than the overall measurement interval T (Δt<<T). For example, the torque measurements can be sampled at least at 1 kHz, 100 kHz, or 1 MHz, while other sampling rates can be used in other embodiments as desired.

In a second example, the drivetrain duty cycle(s) can depend on the peak torque value and/or peak speed value within each subinterval of T, e.g., from time t₀ to time t₁, from time t₁ to time t₂, and from time t₉ to t₁₀. With the above parameters for duty cycles, a first duty cycle includes any peak torque between 1.0 k-1.2 k newton-meters (N·m) at speeds between 2.0 k-2.5 k r/min, while a second duty cycle includes any peak torque between 1.2 k-1.4 k N·m at speeds between 2.0 k-2.5 k r/min. Further in this example, measurements of 1.1 k N·m (peak torque) and 2.1 k r/min from time t₀ to time t₁ would classify within the first duty cycle, while measurements of 1.3 k N·m (peak torque) and 2.4 k r/min from time t₁ to time t₂ would classify within the second duty cycle.

At step 38, the control module determines a useful life reduction. The useful life reduction is based, entirely or in part, on the duty cycle(s) as determined by the control module 16 at step 36. The useful life reduction can be measured in units of time, optionally on the order of several minutes to several thousand hours. In one embodiment, the useful life reduction is calculated by multiplying the drivetrain running time at each duty cycle (e.g., t_{dc1}, in units of time) by a life reduction factor for that duty cycle (e.g., f_{dc1}, dimensionless) and summing each product over the measurement interval T:

Useful Life Reduction=t_{dc1}·f_{dc1}+t_{dc2}·f_{dc2}+ . . . t_{dcn}·f_{dcn} (1)

High duty cycles generally include a life reduction factor f that is greater than the life reduction factor f for low duty cycles. For example, operation of a drivetrain at a high duty cycle, i.e., near upper operating limits, generally includes a greater life reduction factor (e.g., f>>1) than operation of the drivetrain at a low duty cycle, i.e., near lower operating limits (e.g., f≈1). Further by example, operation of a drivetrain at its upper operating limits for 60% percent of the measurement interval T can result in a greater life reduction than operation of the drivetrain at its upper operating limits for 20% percent of the measurement interval T. The life reduction factors are generally stored to a look-up table in memory, but can be modified from time to time as desired. It should be noted that the above methodology is exemplary, and the useful life reduction may be determined according to other methodologies in other embodiments as desired.

A variety of environmental variables can be used to determine the useful life reduction as generally depicted at step 40. These variables can include component temperatures, fluid pressures, fluid conditions, wind speeds, generator speeds, and system vibrations. For example, operation of a drivetrain at a high duty cycle over low environmental temperatures can contribute to fatigue differently than operation the same drivetrain at the same duty cycle but at high environmental temperatures. Further by example, operation of a drivetrain at a high duty cycle in low mileage lubrication oils can contribute to fatigue differently than operation the same drivetrain at the same duty cycle but in high mileage lubrication oils. Accordingly, the control module 16 can process the useful life reduction to include these and other variables as desired.

At step 42, the control module determines a remaining useful life. The remaining useful life is generally determined by reducing the then-existing remaining useful life by the amount of the useful life reduction. The then-existing remaining useful life can be a value stored to computer readable memory. If the drivetrain has not yet been driven under a load, the then-existing remaining useful life is generally equal to the original calculated design life. If the drivetrain has been driven under a load, the then-existing remaining useful life is generally less than the original calculated design life, having been reduced by previous useful life reductions. In this regard, the present method 20 is recursive, applying the immediately prior output—a remaining useful life—as a starting point for the next iteration of method step 42.

As also depicted in FIG. 4, step 42 includes reporting the newly determined remaining useful life. This can include displaying a remaining useful life on a vehicle dashboard or reporting the remaining useful life to equipment operators via one or more electronic signals. This step can also include generating an alert of the remaining useful life approaches an alert value. For example, the control module 16 can generate an alert when the remaining useful life, as measured in hours, is 10% of the original calculated design life. In other embodiments, the control module 16 can generate an alert when the remaining useful life is 5% of the original calculated design. Other alert values can be used in other embodiments where desire.

To reiterate, embodiments of the present invention provide a prognostic tool for determining a remaining useful life based on real time drivetrain measurements. The real time drivetrain measurements can include drivetrain torque, drivetrain speed, and one or more environmental conditions, including for example fluid condition, fluid flow, fluid pressure, bearing temperature, power production, wind speed, generator speed, and vibrations. The prognostic tool converts the measurements into a usable format to determine a continually updated remaining useful life. The remaining useful life is stored into memory for the drivetrain, or for subcomponent(s) of the drivetrain, and is shared with owners, operators, and/or drivetrain maintenance personnel. By determining a remaining useful life based on actual operating conditions, and not predicted operating conditions, the prognostic tool can provide an increased measure of reliability in drivetrain systems over existing methods of failure prediction.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A method for monitoring operation of a drivetrain, the method comprising:
operating the drivetrain over a time interval, the drivetrain having an existing remaining useful life at the beginning of the time interval;
measuring torque at a location along the drivetrain over the time interval and measuring rotational speed of the drivetrain over the time interval;
classifying the operation of the drivetrain into a plurality of duty cycles, the plurality of duty cycles being based on a torque measurement and a speed measurement;
determining a useful life reduction based on the operation of the drivetrain at the plurality of duty cycles during the first time interval; and
subtracting the useful life reduction from the existing useful life value to determine an updated remaining useful life at the conclusion of the time interval.

2. The method of claim 1 wherein the drivetrain forms part of an internal combustion engine, a wind turbine, or a gas turbine.

3. The method of claim 1 further including generating an alert if the remaining useful life is below a minimum value.

4. The method of claim 1 further including displaying a remaining useful life during operation of the drivetrain.

5. The method of claim 1 wherein each of the plurality of duty cycles includes a specified range of torque values at a specified range of rotary speeds.

6. The method of claim 1 wherein:
measuring torque includes sampling torque at a plurality of sub-intervals within the first time interval; and
measuring rotary speed includes sampling rotary speed at a plurality of sub-intervals within the first time interval.

7. A system for monitoring operation of a drivetrain, the system comprising:
a speed sensor configured to measure rotatory speed of the drivetrain;
a transducer configured to measure torque at a location along the drivetrain; and
a control module electrically coupled to the speed sensor and the transducer, the control module including a processor operable to:
determine a duty cycle based on the output of the speed sensor and the output of the transducer, and
calculate an incremental reduction in remaining useful life based on operation of the drivetrain at the determined duty cycle.

8. The system according to claim 7 wherein the drivetrain forms part of an internal combustion engine, a wind turbine, or a gas turbine.

9. The system according to claim 7 wherein the processor is adapted to generate an end-of-useful-life signal when the remaining useful life approaches zero.

10. The system according to claim 7 wherein the processor is adapted to generate an end-of-useful-life signal when the remaining useful life reaches zero.

11. The system according to claim 7 wherein the processor is adapted to determine a duty cycle for each output of the speed sensor and the transducer.

12. The system according to claim 7 wherein the control module continuously records the output of the speed sensor and the transducer to a computer readable memory and periodically samples the rotatory speed and the torque stored to the computer readable memory.

13. A method for monitoring operation of a drivetrain, the method comprising:
periodically measuring drivetrain torque and drivetrain speed during operation of the drivetrain;
determining the drivetrain duty cycle for each measurement, the drivetrain duty cycle being determined as a function of drivetrain torque and drivetrain speed; and
determining a useful life reduction based on the cumulative time of operation of the drivetrain at each of the plurality of duty cycles; and
subtracting the useful life reduction from an existing useful life value to determine a remaining useful life.

14. The method of claim 13 wherein each of the plurality of duty cycles includes a specified range of torque values at a specified range of rotary speeds.

15. The method of claim 13 wherein each of the plurality of duty cycles includes a specified range of peak torque values at a specified range of rotary speeds.

16. The method of claim 13 wherein each of the plurality of duty cycles corresponds to operation of the drivetrain at one of a plurality of gear pairings.

17. The method of claim 13 further including generating an alert when the remaining useful life approaches zero.

18. The method of claim 13 further including displaying a remaining useful life during operation of the drivetrain.

19. The method of claim 13 wherein measuring drivetrain torque includes:
providing a torque transducer at a location along the drivetrain; and
recording the output of the transducer to a computer readable memory.

20. The method of claim 13 wherein measuring drivetrain speed includes:
providing a rotary speed sensor at a location along the drivetrain; and
recording the output of the rotary speed sensor to a computer readable memory.
